(19) United States
(12) Patent Application Publication
(10) Pub. No.: US 2012/0095823 A1
(43) Pub. Date: Apr. 19, 2012

(54) SALE METHOD AND SYSTEM EMPLOYING PRODUCT PRICE VARYING DEPENDENT UPON VALID DATE OF PRODUCT

(75) Inventor: Seung Ho TAK, Seoul (KR)

(73) Assignee: SHT CO., LTD., Seoul (KR)

(21) Appl. No.: 13/274,475

(22) Filed: Oct. 17, 2011

Related U.S. Application Data
(63) Continuation-in-part of application No. 10/381,980, filed on Jun. 11, 2003.

(30) Foreign Application Priority Data
Oct. 2, 2000 (KR) 2000-57864

(51) Int. Cl. G06Q 30/02

(52) U.S. Cl. 705/14.38

(57) ABSTRACT

A sales system includes a bar code scanner, a time stamp bar code adaptor, and a point of sale (POS) terminal. The time stamp bar code adaptor is configured for receiving the bar code scanned by the bar code scanner, extracting the country of origin, the manufacturer code, the product code, the date of production, the valid period, and the ID from the received bar code, and generating a sub code indicative of a ratio of a period, having elapsed from the date of production, to a point of sales, to the valid period. The POS terminal is configured for managing a product code table and a time stamp code table containing discount rate information, and calculating a discount price based on the elapsed period using the bar code and the sub code provided by the time stamp bar code adaptor.

### RELATED APPLICATIONS

This application is a continuation-in-part of Ser. No. 10/381,980 filed Jun. 11, 2003, which claims priority to Korean Application No. 2000-57864 filed Oct. 2, 2000. The disclosures of the above-listed applications are hereby incorporated by reference in their entirety.

### BACKGROUND OF THE INVENTION

1. Field of the Invention

The present invention relates to a sales method and system for varying a product's price according to the expiration date of a product, and more particularly, to a sales method and system employing a product (which has a limited valid period from a manufacture date) whose price is varied according to the period elapsed from a manufacture date, and a bar code and system enabling the sales method and system. The present invention also relates to a dynamic price sales method and system for varying a product's price according to the period elapsed from manufacture date/hour to time of sale and predetermined data relating to a valid period by attaching a bar code, which includes the manufacture date/hour and predetermined data relating to a valid period, to the product or by printing the bar code.

2. Description of the Related Art

In general, in a case where products such as foods and medicines, are dealt among a manufacturer, a supplier, a seller, a distributor, and a customer, the products may deteriorate or decay during the distribution process and do harm to the human body. Thus, a valid period from the manufacture date of the products must be clearly indicated. As shown in FIG. 1, a bar bode (15) is attached to a product produced by a manufacturer (10), the product is transported and delivered (20), and the transported product is sold by a seller and distributor (30). In general, products with a faraway expiration date are sold and distributed at a uniform price, and products with an upcoming expiration date are discounted. The uniform price of products is calculated at a point-of-sale (POS) terminal (40). Bought products are consumed immediately or kept in cold storage (50). Products that have not been purchased but whose expiration date (D+5) has passed are thrown out and thus wasted (60). The likelihood of a product being purchased increases (32) for products manufactured more recently and decreases (34) for products manufactured a while ago. In other words, when choosing among products having the same price, customers prefer the product with the most time remaining until the expiration date.

As a result, many foods and medicines do not get sold during the distribution process, exceed the valid period, and are wasted. In the case of some specific foods, 30-50% of the total production is wasted. The waste cost first affects the distributor and the seller, then gets passed on to the producer and the supplier, and then finally, is included in the manufacturing cost and passed on to the customers.

In smaller grocery stores or traditional markets, there is a limited number of products available for purchase. Both sellers and customers can determine the freshness of a product by visual inspection or smell. As a result, sellers can give individualized discounts on items that are not as fresh. However, in larger markets such as supermarkets and hypermarkets, which offer many different kinds of products and use a large-scale sales method, customers selectively purchase products having the most recent manufacture date/hour, and thus it is very difficult to sell products according to first-in first-out. As a result, in order to clear stocks before expiration dates, products are discounted. Nevertheless, a certain percentage of the products remain unsold, exceed the valid periods, and are wasted.

POS terminals and bar code scanners are introduced and used in stores such as convenience stores, supermarkets, grocery stores, liquor stores, drugstores, cosmetic stores, and merchandise stores to facilitate accurate, convenient, and easy sales and for inventory control. Information such as the place of origin, manufacturer, and article code, for example, KAN, JAN, and EAN, are included in the bar code printed on the product. A bar code scanner at the POS terminal recognizes the bar code, and thus a price corresponding to a previously-entered article code is automatically displayed. The POS terminal is connected to a database of a server and is used to check sales stands for items, stocktaking, and automatic dispatch of order sheets for items with a decreased stockpile.

However, data relating to a manufacture date are not included in a conventional bar code. In general, a manufacture date and a valid period do harm to the human body. Thus, the expiration date and the manufacture date are separately printed on a specific part of a product for the purpose of quick visual identification, and a product's price cannot be automatically calculated at the POS terminal.

Further, since the data relating to manufacture date and time are not included in the conventional bar code, a manufacture date is printed on a separate position from where a bar code is printed, and a product must be sold at a uniform price regardless of the valid period, customers selectively purchase the most recently manufactured product. As a result, a product more than a couple of days old is wasted by time elapse due to a continuous vicious cycle, and wasting the product exceeding the valid period requires enormous costs, and problems related to processing environmental pollutants such as dioxins, occur during the wasting process. As a result, a lost revenue is large, and the loss is included in the manufacture and supply cost, and thus customers must purchase products whose price reflects the lost revenue.

In other words, all products are distributed according to sales profits excluding a difference between a purchasing price and a selling price, and a selling cost. Prices of products such as foods, medicines, cosmetics, and liquor, which all have limited valid periods, are uniform at a purchasing time and sold at uniform prices, and thus customers prefer the most recently manufactured product. As a result, in a case where there are stockpiles of products that did not get purchased on the first day of sales, the products are proffered the next day. However, customers prefer fresh products to three day-old products, so some of the day-old products remain unsold and are once again put out the next day. This vicious cycle continues until the products exceed the valid period and are wasted. The costs of the wasted products are passed on to the customers whether the distributor or the manufacturer bears a lost revenue or not, and due to problems such as environmental pollution caused by waste, and the costs of the wasted products, enormous costs accrue.

Waste of products can be prevented by a method for managing stocks through sales by providing an exceptional discount at a time approaching an expiration date. However, the quantity of products remaining since a purchasing date cannot be accurately checked, so stocks remain, and a vicious cycle inevitably occurs.

Further, since data relating to an expiration date are not included in a bar code, the expiration date of a product is separately attached to the product, or printed data relating to an expiration date is to be referred to manually, determining the expiration date, or calculating a differential discount price becomes complicated.

### SUMMARY OF THE INVENTION

It is a first feature of the present invention to provide a sales method for varying a product's price according to the expiration date of the product.

It is a second feature of the present invention to provide a dynamic price sales method for varying a product's price according to the time elapsed from the manufacture date/hour to time of sale and according to predetermined data relating to the valid period by attaching a bar code that includes the manufacture date/hour and the predetermined data relating to the valid period to the product or by printing the bar code.

It is a third feature of the present invention to provide a sales system for varying a product's price according to the expiration date of the product.

It is a fourth feature of the present invention to provide a dynamic price sales system for varying a product's price according to the time elapsed from the manufacture date/hour to time of sale and according to predetermined data relating to the valid period by attaching a bar code that includes the manufacture date/hour and the predetermined data relating to the valid period to the product or by printing the bar code.

It is a fifth feature of the present invention to provide a code for determining a product's price, the code including a time stamp bar code as an extended or separate sub bar code, in a bar code for automatically recognizing the product.

It is a sixth feature of the present invention to provide a bar code for indicating the valid period in order to implement the sales method for varying a product's price according to the expiration date of the product.

It is a seventh feature of the present invention to provide a bar code which includes the manufacture date/hour of a product, predetermined data relating to the valid period, and a predetermined identifier in a bar code for automatically recognizing a product including the country of origin, a manufacturer code, and an article code.

It is an eighth feature of the present invention to provide a bar code system employing a bar code for indicating the valid period in order to implement the sales method employing a product's price according to the valid period of the product.

In accordance with one aspect of the present invention, there is provided a sales method for varying the price of a product according to the elapsed period from a manufacture date/hour to time of sale by attaching the manufacture date/hour of a product to the product itself or by printing the manufacture date/hour of the product on the product in a sales method of products, each having an expiration date.

In accordance with another aspect of the present invention, there is provided a sales system in which a discount rate table and prices according to the time elapsed from a manufacture date/hour to time of sale determined by a point of sale (POS) server are transmitted through wires or wireless modem to be displayed on a price indication terminal at a display stand and are downloaded simultaneously into a POS counter and recorded in the POS counter, and the time elapsed from manufacture date/hour to time of sale is calculated by a real time clock (RTC) at the POS counter so that a discount rate and prices are determined, and a product's price is displayed to a customer.

In accordance with another aspect of the present invention, there is provided a sales system. The sales system includes a bar code including data on the country of origin, a manufacturer code, and an article code and further including a manufacture date/hour of a product, predetermined data relating to a valid period, and a predetermined identifier, a bar code scanner for scanning the bar code, a time stamp bar code adaptor for reading the manufacture date/hour, the valid period, and the identifier from the contents of the bar code scanned by the bar code scanner and calculating a price varied according to the period elapsed from the manufacture date/hour to time of sale, the valid period, and the identifier, and a point of sale (POS) terminal for receiving a varied price from the time stamp bar code adaptor.

In accordance with another aspect of the present invention, there is provided a sales system. The sales system includes a bar code including the country of origin, a manufacturer code, and an article code and further including the manufacture date/hour of a product, predetermined data relating to a valid period, and a predetermined identifier, a bar code scanner for scanning the bar code, and a point of sale (POS) terminal comprising a program for reading the manufacture date/hour, the valid period, and the identifier from the contents of the bar code scanned by the bar code scanner and calculating a price varied according to the period elapsed from the manufacture date/hour to time of sale, the valid period, and the identifier, and a real time clock (RTC).

In accordance with another aspect of the present invention, there is provided a sales system. The sales system includes a bar code including the country of origin, a manufacturer code, and an article code and further including manufacture date/hour of a product, predetermined data relating to a valid period, and a predetermined identifier, a bar code scanner for scanning the bar code, reading the manufacture date/hour, the valid period, and the identifier, and calculating a price varied according to the period elapsed from the manufacture date/hour to time of sale, the valid period, and the identifier, the bar code scanner comprising a real time clock (RTC), and a point of sale (POS) terminal for receiving a varied price from the bar code scanner.

In accordance with another aspect of the present invention, there is provided a code for determining a varied price of a product, the code including a time stamp bar code as an extended bar code or a separate sub bar code is in a bar code used for automatic recognition of the product.

In accordance with another aspect of the present invention, there is provided a bar code comprising a manufacture date/hour and predetermined data relating to a valid period, wherein the bar code is included in or separately attached to another bar code, which includes the country of origin, a manufacturer code, and an article code, used for automatic recognition of a product.

In accordance with another aspect of the present invention, there is provided a bar code system for reading data relating to a price employing a discount rate varied in units of time according to the period elapsed from a manufacture date/hour indicated on a sub bar code that was included in or separately attached to a conventional bar code that the price can be automatically calculated when manufacturing a product and/or forwarding the product from a factory.

It is preferable that a discount rate is calculated according to units of hours or days from a manufacture date/hour to time of sale in order to sell products that have a limited valid period at a varied price.

It is also preferable that the price of a product is varied according to the elapsed period from a manufacture date/hour to time of sale and according to data relating to a valid period by attaching the data relating to a valid period of the product to the product itself or by printing the data relating to a valid period on the product.

It is also preferable that a discount rate is calculated according to the elapsed period from a manufacture date/hour to time of sale and according to the valid period in order to sell products at a varied price. a predetermined identifier is further attached to the product or printed on the product, and the data relating to a valid period are indicated in units of hours when the identifier denotes time, indicated in units of days when the identifier denotes a day, and indicated in units of months when the identifier denotes a month.

It is also preferable that when data relating to a valid period is indicated by ‘0’ for a product, the product does not have a valid period.

It is also preferable that a hybrid sales method is provided by applying a traditional sales method for giving reductions and something extra when sellers and distributors sell foods face-to-face to customers in a smaller grocery store or a traditional market, to a large-scaled market such as a supermarket, a hypermarket, and a mass-sales store.

It is also preferable that when purchasing a product via an internet network, mobile communications, or internet cyber trading, display video data are provided on a monitor at a lower end portion and side of a screen of the monitor so that a product can be selected after checking the discount rate according to the time elapsed from the manufacture date/hour to time of sale, the price, the date when the product was stored in a warehouse, and data relating to a valid period while seeing the actual product at a display stand through a camera.

It is also preferable that the product is sold to a specific purchaser such that the specific purchaser requesting a reservation purchase through internet can purchase products, which are bought periodically by the specific purchaser, at the cheapest price through cyber trading.

It is also preferable that the product is sold to a purchaser according to some questions such as price preferred, time preferred, regardless if the product was purchased and then returned to a seller, for determination of priority.

It is also preferable that a method for preventing sales receipt fabrication in which a signed sales receipt is put in an electronic envelope and can be only opened by a code key of banking facilities such that an individual trader cannot fabricate a sales receipt is employed.

It is also preferable that the price indication terminal further includes a bar code reader for inquiring about the current price of a product selected by a customer.

It is also preferable that the system further includes a camera used to observe products at sales stands, and a supplier can check whether or not a competitor's product is being displayed at the supplier's own display stand.

It is also preferable that when purchasing a product via an internet network, mobile communications, or internet cyber trading, display video data are provided on a monitor at a lower end portion and side of a screen of the monitor so that a product can be selected after checking the discount rate according to the time elapsed from the manufacture date/hour to time of sale, the price, the date when the product was stored in a warehouse, and data relating to a valid period while seeing the actual product at a display stand through a camera.

It is also preferable that the product is sold to a specific purchaser such that the specific purchaser requesting a reservation purchase through the Internet can purchase products, which are bought periodically by the specific purchaser, at the cheapest price through cyber trading.

It is also preferable that the product is sold to a purchaser according to some questions such as price preferred, time preferred, and not asked about a returned product, for determination of priority.

It is also preferable that the system further includes an audio apparatus for sensing the presence of a human body by an infrared manual and automatic sensing method and for transmitting data related to a product to a customer when a person approaches the price indication terminal installed in front of the display stand.

It is also preferable that an elasticity sensor, a sugar content sensor, a salt content sensor, and a moisture sensor are installed near a targeted sales product so that a customer can know the elasticity, sugar content, salt content, and moisture of the targeted sales product in a market or a remote place without having to be there in person.

It is also preferable that the time stamp bar code adaptor includes a digital filter, a real time clock (RTC) having the present date and time, and an operator for calculating a valid period. The digital filter outputs a conventional article code, such as EAN, KAN, and JAN, to transmit to the POS terminal when the conventional article code is recognized by the bar code scanner and entered into the bar code scanner, and the digital filter transmits a time stamp bar code including the manufacture date/hour, predetermined data relating to a valid period, and a predetermined identifier to the operator for calculating a valid period when the time stamp bar code is recognized by the bar code scanner and entered into the bar code scanner, and the operator for calculating a valid period calculates a price varied according to the period elapsed from the manufacture date/hour to time of sale, the valid period, and the identifier, which are entered into the digital filter.

It is also preferable that the time stamp bar code adaptor further includes a display unit for displaying the present date and time of the RTC, and a correction board such as a button for correcting the present date and time.

It is also preferable that the system further includes a price inquiry apparatus, and the price inquiry apparatus records data relating to temperature and humidity according the time elapsed from the manufacture date/hour to time of sale at a place where the product is stored or displayed when the price of a product to which a time stamp bar code is attached is checked.

It is also preferable that the POS terminal further refers to data relating to temperature and humidity at a place where the product is stored or displayed when the price of a product is checked.

It is also preferable that the bar code scanner further refers to data relating to temperature and humidity at a place where the product is stored or displayed when the price of a product is checked.

It is also preferable that the code is a bar code, a non-contact IC card, or a RF-ID tag. It is also preferable that the wrapping paper of a product leaves empty space on the right side of a conventional article bar code, and the time stamp bar code is additionally recorded on the day of manufacture and printed along with a valid period and the manufacture date, which can be easily spotted visually by customers so that dual tasks can be prevented and a time stamp bar code can be attached to the code when the code is a bar code.

It is also preferable that the added bar code is printed by an ink jet printing method, a heat-transfer printing method, or a heat-reduction printing method, a basic code is printed at the back side of the wrapping paper, and an additional code is stamped or printed at the front side of the wrapping paper so that a sub bar code, in which manufacture date is recorded is additionally recorded during production of the product, which has a wrapping paper that is made of a transparent material, in order to prevent the time stamp bar code from being fabricated and altered during distribution.

It is also preferable that the sub bar code corresponding to data such as a storage place and method as well as manufacture date/hour, is added to a product, such as wine, whose commercial value increases with time from the manufacture date/hour.

It is also preferable that a predetermined identifier is further included in the bar code, and the data relating to a valid period are indicated in units of hours when the identifier denotes a time, indicated in units of days when the identifier denotes a day, and indicated in units of months when the identifier denotes a month.

It is also preferable that when the data relating to a valid period is indicated by ‘0’, the product does not have a valid period.

It is also preferable that an electronic signature is introduced such that a trader cannot deny a sales act during trading.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an example of a conventional distribution path of a product having an expiration date;

FIG. 2 illustrates an example of a sales method for varying a product's price according to the expiration date of the product, according to a first preferred embodiment of the present invention;

FIG. 3 illustrates a sales system employing the sales method of FIG. 2 for varying a product's price according to the expiration date of the product;

FIG. 4 illustrates an example of a bar code according to the present invention;

FIG. 5 illustrates a dynamic price sales system according to a second preferred embodiment of the present invention;

FIG. 6 illustrates a display unit of a time stamp bar code adaptor (TSBA);

FIG. 7 illustrates an example of a time stamp bar code (TSB) being generated, attached, and printed;

FIG. 8 illustrates an example in which the TSBA of FIG. 6 is applied between a conventional bar code scanner and a POS terminal;

FIG. 9 illustrates an example of a TSB algorithm implemented by software in a conventional POS terminal and a database;

FIG. 10 illustrates an example of a TSB function being applied to a bar code scanner having a real time clock (RTC);

FIG. 11 illustrates an example of a time stamp being applied to a radio frequency (RF)-ID;

FIG. 12 illustrates a present price inquiry apparatus of a product employing a TSB;

FIG. 13 illustrates an example of present price inquiry of a product employing a TSB;

FIG. 14 illustrates a dynamic price sales method having time elapsed, and a stock-optimization enhanced structure;

FIG. 15 a method for reducing a manufacturing cost resulting from inventory control according to time elapsed for each item and calculation of reasonable production according to time;

FIG. 16 illustrates a method for calculating a dynamic price of an item, which is perishable, according to the time elapsed from distribution;

FIG. 17 illustrates a method for indicating a discount rate according to time by a TSB index; and

FIG. 18 illustrates a TSB sales algorithm.

### DETAILED DESCRIPTION OF THE INVENTION

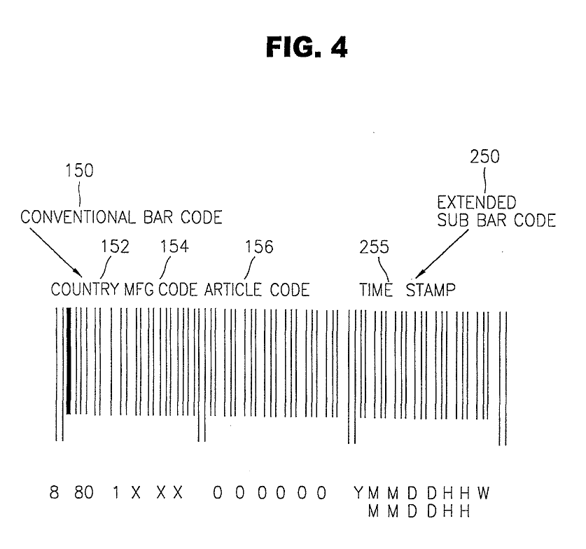

The present invention keeps in close contact with and is applied to a conventional point of sale (POS) by introducing a technique for determining a product's price according to the expiration date of the product. As a result, items such as foods and medicines having a limited valid period are sold at prices varied according to time from manufacture date/hour so that customers determine purchasing at prices varied according to the date and time elapsed from the manufacture date/hour. For this purpose, in a first preferred embodiment of the present invention, as shown in FIG. 4, an extended sub bar code 250 is added to a conventional bar code 150. The conventional bar code 150 includes a country code 152, a manufacturer's (Mfg) code 154, and an article code 156, and the extended sub bar code 250 includes a time stamp 255. The time stamp 255 is comprised of YMMDDHHW or MMDDHH. Y, M, D, H, and W denote year, month, date, hour, and day, respectively. The extended sub bar code 250 may be comprised of 8-order or 6-order data, but this may be increased or decreased according to a designer's preference. It is preferable that the wrapping paper of a primarily printed product leaves space on the right side of a conventional article bar code for the extended sub bar code 250. A time stamp bar code is additionally recorded on the date of manufacture and printed along with an expiration date and a manufacture date, which can be easily spotted by customers, so that dual tasks can be prevented. In order to prevent the time stamp bar code from being fabricated and altered during distribution, the extended sub bar code 250 is first printed by an ink jet or a heat transfer printing method. Second, a basic code is printed at the back side of the wrapping paper, and an additional code is stamped or printed at the front side of the wrapping paper so that a sub bar code containing information or the manufacture date is additionally recorded during production of the product. Here, the wrapping paper is made of a transparent material.

A bar code is used in the first preferred embodiment. Instead of a bar code, a non-contact IC card, a RF-ID tag, or a similar calculation and managing method may be used, and a manufacture date may be applied by using a bar code as well as a non-contact IC card, the RF-ID tag, or the similar calculation and managing method. That is, the bar code is favored as the most appropriate for sales in a large-scaled market, but a method for calculating products selected by customers by using a RF-ID tag or non-contact IC card may be introduced in the present invention.

A sub bar code corresponding to data such as a storage place and method as well as manufacture date/hour can be added to products whose commercial value increases over time (i.e., from the manufacture date) in addition to products whose commercial value decreases over time (i. e., from the manufacture date). An example of a product whose commercial value increases over time is wine.

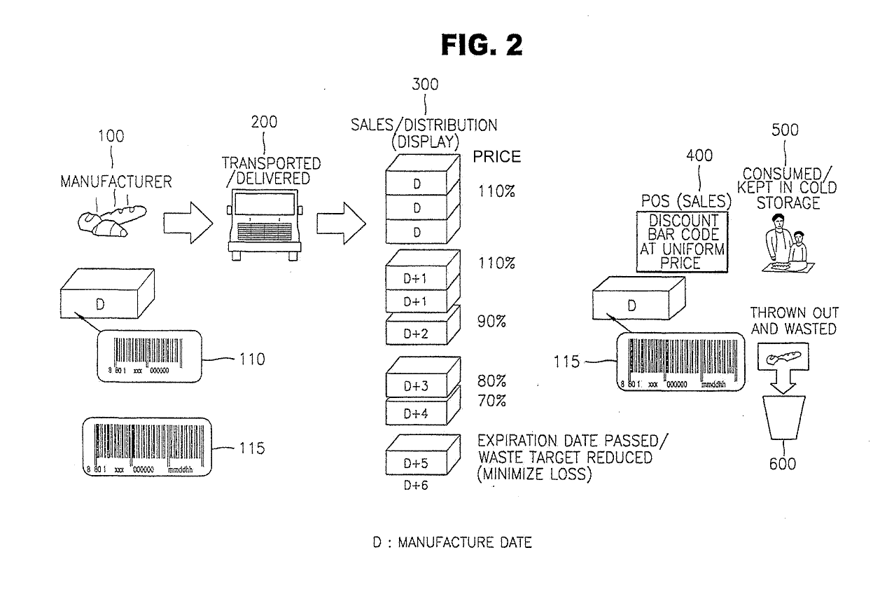

Hereinafter, a sales system for varying a product's price according to the valid period of the product which includes the above-mentioned bar code will be described with reference to FIG. 2.

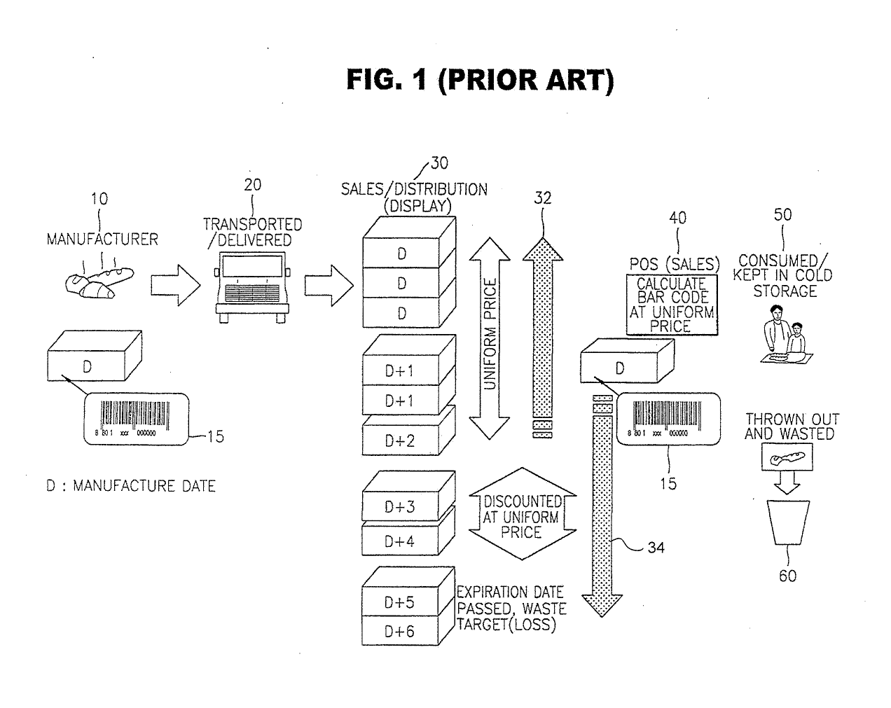

A sales system similar to the sales system of FIG. 1 is shown in FIG. 2. That is, in FIG. 2, a bar code (110) including basic data of a product is primarily printed and attached to a product produced by a manufacturer (100), and then a time stamp sub bar code (115) is additionally printed and attached to the product. Here, the time stamp sub bar code means an extended bar code. The product is transported and delivered (200), and the transported product is sold by a seller and distributor (300). In general, products within a valid period are sold and distributed at prices varied according to the valid period, and products approaching the expiration date are discounted. The prices of these products are calculated at a point-of-sale (POS) terminal (400) according to the valid period. In such a case, the manufacture date/hour attached to the product is read by the POS terminal (400), and then the prices of the products are calculated. Then, customers consume the products or keep them in cold storage (500). Products which have not been purchased and exceed the expiration date (D+5 and D+6) are thrown out and wasted (600).

Referring to FIG. 2, as an example, the time stamp sub bar code may be a time stamp indicated by “072109”, which means that the product was manufactured on July 21, at 9:00 am. In a case where the time stamp sub bar code is indicated by “00721235”, which means that the product was manufactured on Jul. 21, 2000, Friday at 23:00 pm. Further, the price of a product, which is varied according to the present invention, is calculated to be 110% of the normal selling price in a case where the product is purchased on the date of manufacture (D) because it takes time to transport and deliver the product.

Further, in a case where the product is purchased one day after the manufacture date, the price of the product is calculated to be 100% of the normal selling price. In a case where the product is purchased two days after the manufacture date, the price of the product is calculated to be 90% of the normal selling price. In a case where the product is purchased three days after the manufacture date, the price of the product is calculated to be 80% of the normal selling price. In a case where the product is purchased four days after the manufacture date, the price of the product is calculated to be 70% of the normal selling price. As a result, the product is sold at a discount of 10-30% off the normal selling price. In a case where the product remains unpurchased four or more days from the manufacture date, the product is thrown out and wasted.

As described above, a discount rate may be applied in increments of 10% according to the date elapsed since the manufacture date. However, in a case where a customer purchases foods distributed on the date of manufacture, 100% of the selling price is applied at a time when foods are displayed in a market, and 1% of the selling price is discounted for each hour that has elapsed from the manufacture date in consideration of a lost revenue according to the time elapsed from the manufacture date.

As mentioned above, customers can benefit from a discount of 10% or more by selecting a product that was not made that same day. Thus, foods having an expiration date can be sold on a first-in first-out at varied basis.

By introducing a new sales method, as described above, losses caused by perishing products provided by manufacturers and suppliers can be reduced. Further, losses to sellers and distributors can be reduced. As a result, the benefits of customers' selection of a discounted product can be returned to customers, thereby increasing the revenue of manufacturers, suppliers, sellers, and distributors and also returning profits instead of passing along losses to customers.

The sales method of bar code products having an added manufacture date/hour according to preferred embodiments of the present invention should be used in a conventional bar code system. That is, various discount rates according to information encoded on an extended bar code of the present invention, such as the date and time elapsed from the manufacture date should be applied by the extended bar code according to the present invention when calculating the price of a product at a POS terminal.

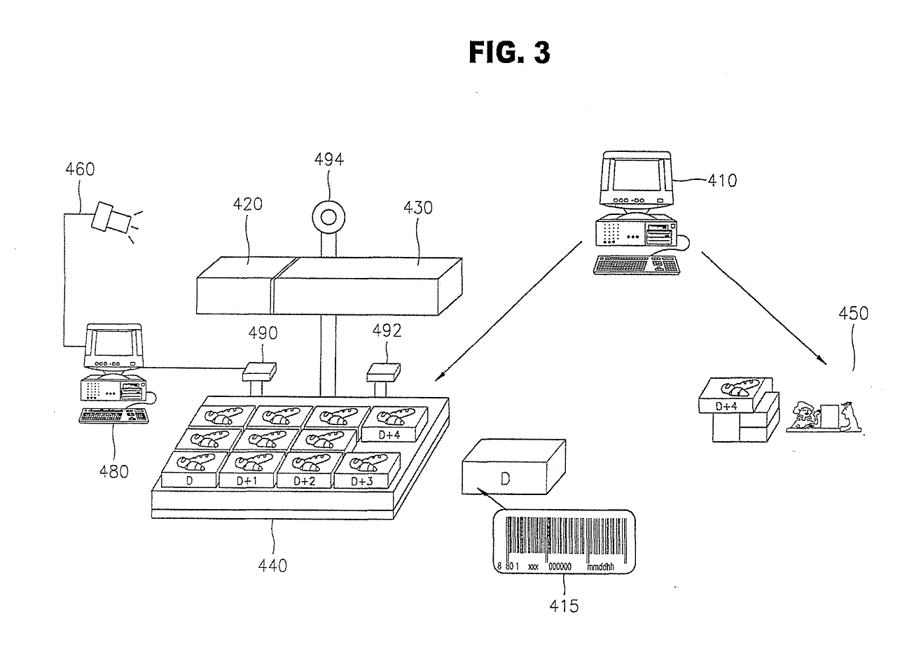

Referring to FIG. 3, manufacture date and time of data relating to a manufacture date or a valid period which can be easily spotted visually are additionally recorded on products according to the present invention so as to be read continuously from the back side of a conventional bar code, or an extended bar code 415 on which separate time data are recorded is added to the products, which are placed on a display stand 440. The display stand 440 includes a first display 420 on which basic data relating to kinds and prices of articles are displayed, and a second display 430 on which discounted prices are displayed, thereby allowing customers to select discounted products where the discounted prices are determined by a program and provided from a POS server 410 to the second display 430 of the display stand 440. However, in general, such discounted prices can be included in the extended bar code 415, and thus a discounted price code indicated in the extended bar code 415 can be read when calculating the price of a product being purchased at a counter 450 to apply a discounted rate on the basis of time elapsed from manufacture date/hour for exact calculation. In such a case, data provided to the second display 430 are previously programmed into the POS server 410 and transmitted to the display stand 440 and counter 450.

If a discount is determined by the POS server 410, a discount rate and discounted price according to time elapsed from a manufacture date/hour, which are determined by the POS server 410, are transmitted to a price indication terminal 430 shown in FIG. 3 and displayed on the price indication terminal, and simultaneously, are downloaded into the counter 450. Time elapsed is calculated by a real time clock (RTC) of the counter 450 at check-out time, and thus, a discount rate and a discounted price is determined and presented to customers.

The price indication terminal automatically displays indicates a discount rate and a discounted price at time of sale elapsed from manufacture date/hour on the display stand 440, and the discount rate and the discounted price can be applied when products selected by customers are brought to the counter 450.

Meanwhile, although not shown, when purchasing a product through cyber trading such as on the internet, a desired product can be selected while checking the discount rate according to the time elapsed from manufacture date/hour to time of sale, the price, the date when the product was stored in a warehouse, and the valid period, which are displayed at in a lower end portion and side of a screen of a monitor, while seeing the actual product at a display stand through a camera 460.

In this way, the present invention is applied to an internet e-commerce site so that customers can purchase products at prices varied according to valid periods. For this purpose, the camera 460, an internet server 480, and all kinds of sensors 490 and 492 for sensing the freshness and quality of products may be included. A supplier can check through the camera 460 whether a competitor's product is being displayed or not. Display video data may be provided for selecting a product after checking the discount rate according to the time elapsed from manufacture date/hour to time of sale, the price, the date when the product was stored in a warehouse, and the valid period, while seeing the actual product at a display stand through a camera when purchasing the product through an internet network, mobile communications, or internet cyber trading.

As shown in FIG. 3, all kinds of sensors 490 and 492, such as an elasticity sensor, a sugar content sensor, a salt content sensor, and a moisture sensor, are installed in a targeted sales product so that a customer can know the freshness and quality of products in a market or so that a customer connecting through the internet server 480 can know the elasticity, sugar content, salt content, and moisture of products in a remote place without having to be there in person. In this way, in the present invention, the price of a product and a lost revenue according to time elapsed are calculated, and a bargain price can be determined and discounted when purchasing products having lower freshness.

Meanwhile, as shown in FIG. 3, the sales system further includes an audio apparatus 494 for transmitting data related to a product to a customer when the customer approaches the price indication terminal installed in front of the display stand 440. Here, the audio apparatus, which senses the presence of a human body by using an infrared manual and automatic sensing method, is a MP3 decoder having an infrared sensor. Thus, data relating to a product are automatically indicated for a customer when a person approaches the price indication terminal, thereby promoting customer's purchasing.

As described above, it is effective to install and operate a price indication terminal for informing a discount rate to customers when a product to which a manufacture date is attached is sold in a supermarket or hypermarket and for indicating the price of a customer's selection. That is, a terminal for determining the characteristics and a lost revenue according to a valid period of a product elapsed from manufacture date/hour, applying a discount rate, and indicating the price and discount rate of the product at a display stand is required. The price indication terminal is connected to a conventional POS server, shares data such as price and discount rate with a POS terminal, and reads the discount rate of a product selected by a customer so that the discount rate can be applied to the calculation of the product's price.

As a result, when customers select products where which discount rate is varied according to date and time elapsed from manufacture date/hour, the amount of wasted products can be reduced because perishable products are purchased on a first-in first-out basis rather than a last-in first-out basis. There was no choice for a conventional point of sale (POS) and a conventional bar code calculation method. However, in the present invention, data such as manufacture date/hour can be recorded as an extended bar code of a bar code and provide a price varied according to the time elapsed from manufacture date/hour by employing a new sales method. Thus, this new sales method offers customers the benefit of selecting a discounted product to and returns a higher revenue to a manufacturer, supplier, distributor, and seller. Also, the new sales method has more competitive power than the conventional sales method.

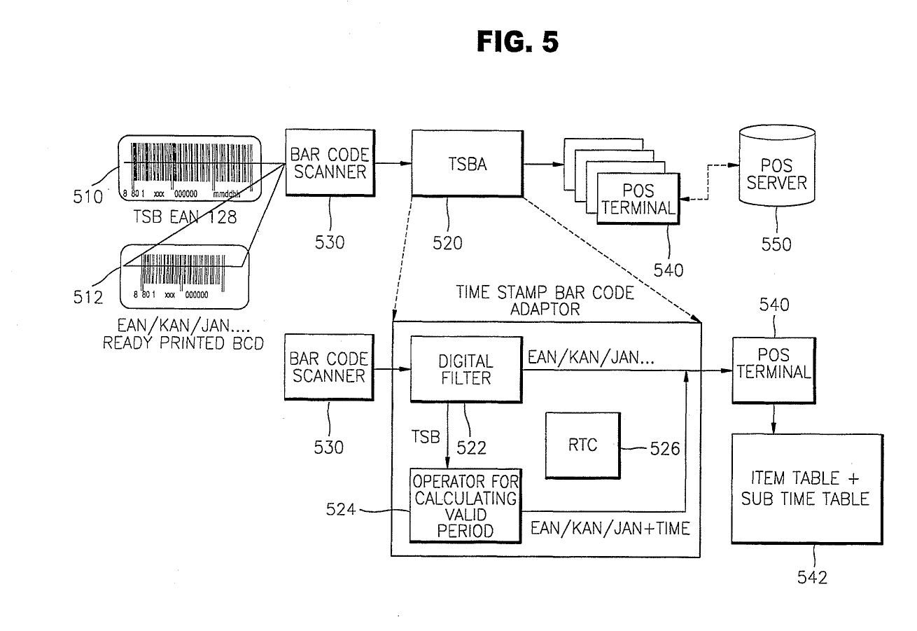

FIG. 5 illustrates an example of a dynamic price sales system according to a second preferred embodiment of the present invention. Referring to FIG. 5, the dynamic price sales system includes a bar code 510, a bar code scanner 530, a time stamp bar code adaptor 520, and a POS terminal 540.

The dynamic price sales system can be also recognized by a conventional bar code 512 including the country of origin, a manufacturer code, and an article code. The bar code 510 further includes manufacture date/hour, a predetermined valid period, and a predetermined identifier as well as the country of origin, the manufacturer code, and the article code. Both the conventional bar code 512 and the bar code 510 according to the present invention can be scanned by a conventional bar code scanner 530.

Further, the time stamp bar code adaptor 520 (hereinafter, referred to as a TSBA') for recognizing the bar code 510 according to the present invention in a conventional POS terminal 540 is located between the bar code scanner 530 and the POS terminal 540. The TSBA 520 reads the manufacture date/hour, the valid period, and the identifier among the contents of the bar code scanned by the bar code scanner 530 and calculates a price varied according to the period elapsed from the manufacture date/hour to time of sale, the valid period, and the identifier. The price calculated is output to the POS terminal 540 from the TSBA 520.

The TSBA 520 includes a digital filter 522, a real time clock 526 (hereinafter, referred to as a ‘RTC’) having present date and time, and an operator 524 for calculating a valid period. The digital filter 522 outputs a conventional bar code 512 such as EAN, KAN, and JAN, to be transmitted to the POS terminal when the conventional bar code 512 is recognized by the bar code scanner 530 and entered into the bar code scanner 530. Further, the digital filter 522 transmits a bar code 510 of a time stamp (hereinafter, referred to as a ‘TSB’) including a manufacture date/hour, a predetermined valid period, and a predetermined identifier to the operator 524 for calculating a valid period when the TSB 510 is recognized by the bar code scanner 530 and entered into the bar code scanner 530. The operator 524 for calculating a valid period calculates a price varied according to the period elapsed from the manufacture date/hour to time of sale, the valid period, and the identifier, which are entered into the digital filter 522. For example, the operator 524 for calculating a valid period calculates time elapsed by subtracting the present time of the RTC 526 from the valid period to the manufacture date/hour of the TSB 510, thereby dividing the time n-times, adding an extended bar code to a conventional bar code, and outputting the extended bar code. The POS terminal 540 is connected to a POS server 550, transmits and receives data relating to a sale, and displays an item table and sub time table 542.

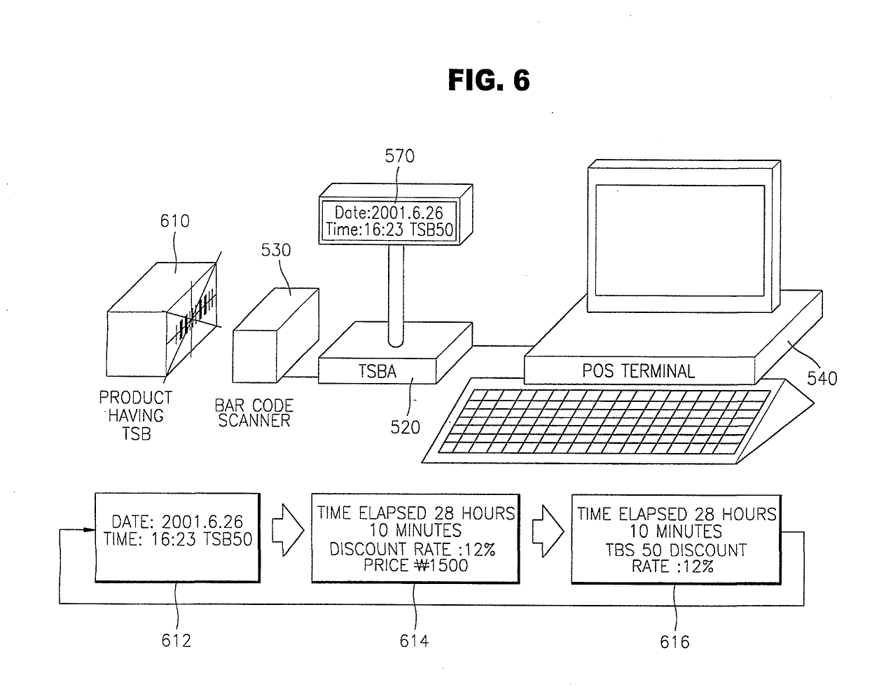

FIG. 6 illustrates a display unit 570 of the TSBA 520. Referring to FIG. 6, the TSBA 520 further includes the display unit 570 for displaying the present date and time of the RTC and a correction board (not shown) such as a button for correcting the present date and time. An example of a screen displayed on the display unit 570 is shown by reference numerals 612, 614, and 616. First, the present date, the present time, and an identification number of a product having a TSB, for example, TSB50, are displayed on the display unit 570 (612). Next, time elapsed calculated by the operator 524 (FIG. 5) for calculating a valid period, a discount rate, and a varied price are displayed on the display unit 570 (614). Then, the time elapsed, the identification number TSB50, and the discount rate are displayed on the display unit 570 (616). Subsequently, as shown by reference numeral 612, the order in which present date, present time, and the identification number TSB50 are displayed is circulated at a predetermined interval, or by entering a predetermined button. The present date and time is displayed on the display unit 570 so that a customer can check the present time when the price of the product 610 having a TSB is calculated. Further, the RTC in the TSBA 520 has a button for adjusting the clock displayed on the display unit 570, such as a liquid crystal display (LCD), the TSBA 520, or the RTC in the TSBA 520 is synchronized with a clock of the TSBA 520 by software separately provided to the POS server 550 (FIG. 5) or the POS terminal 540.

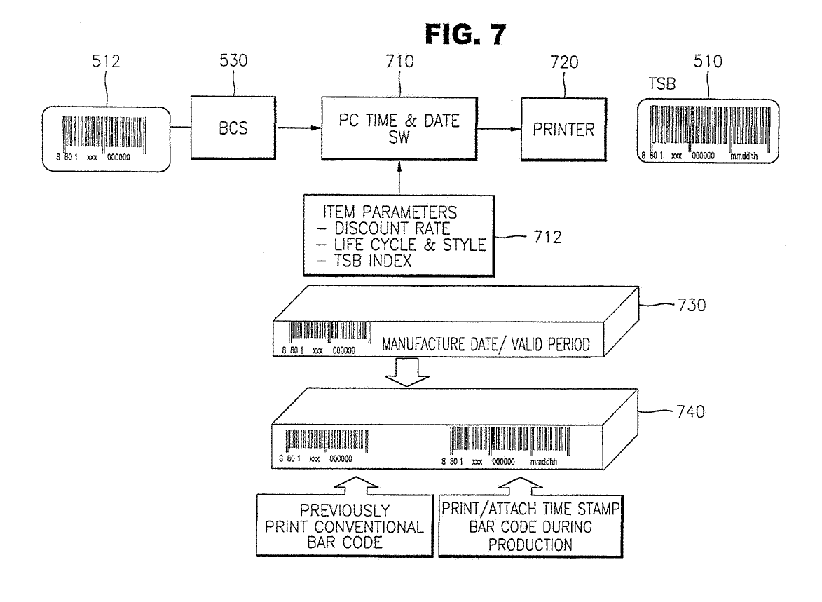

FIG. 7 illustrates an example of the TSB 510 is being generated, attached, and printed. Referring to FIG. 7, the TSB 510 includes the manufacture data/hour and predetermined data relating to the valid period, which may be included as a separate bar code or an extended bar code attached to the TSB 510, as well as the country of origin, a manufacturer code, and an article code, which are included in the conventional bar code 512. The TSB 510 further includes a predetermined identifier. Data relating to the valid period are indicated in units of hours when the identifier denotes time, in units of days when the identifier denotes a date, and in units of months when the identifier denotes a month. Further, the product is a product having no valid period or life cycle when the data relating to the valid period are indicated by ‘0’.

More specifically, the TSB 510 is separately attached to the product during production by including time expiration data in the conventional bar code comprising the country of origin, a manufacturer's code, and an article code. The time expiration includes three-order data relating to a valid period XXX (from 000 to 999), an identifier for indicating time, date, or month, and a manufacture date YYMMDD or MMDDHH. When the identifier denotes time, manufacture date is given by MMDDHH for month/date/hour, and the data relating to the valid period are indicated in units of hours from 000 to 999. When the identifier denotes a date, manufacture date is given by YYMMDD for year/month/date, and the data relating to the valid period are indicated in units of days from 000 to 999. When the identifier denotes a month, YYMMDD for year/month/date, and the data relating to the valid period are indicated in units of months from 000 to 999. When the data relating to the valid period are indicated by ‘000’, the product does not have a valid period.

There are limitations to the number of order of the conventional bar code, and thus time cannot be added to the conventional bar code. Thus, a conventional bar code, a valid period, an identifier, and a manufacture data/hour are added by using an EAN16 code which can be recognized by conventional bar code scanners.

A conventional bar code 742 is already printed on the wrapping paper of a product, and a manufacture date and a valid period are printed separately or attached when products are supplied for sale. A manufacture time such as manufacture year/month/date/hour, is indicated in a TSB 744. The TSB 744 cannot already be attached to the wrapping paper, is printed using a printer 720 by a computer 710 for indicating the present time and date of production, is attached separately to the wrapping paper, or printed on the wrapping paper (740). Item parameters 712 such as a discount rate, life cycle and style, and a TSB index are referred to by the computer 710. The Arabic numerals of a manufacture date, which can be easily spotted visually, are separately indicated, and printed or attached (730) so as not to be in conflict with legal indications for safety in distribution of foods and protection of customers.

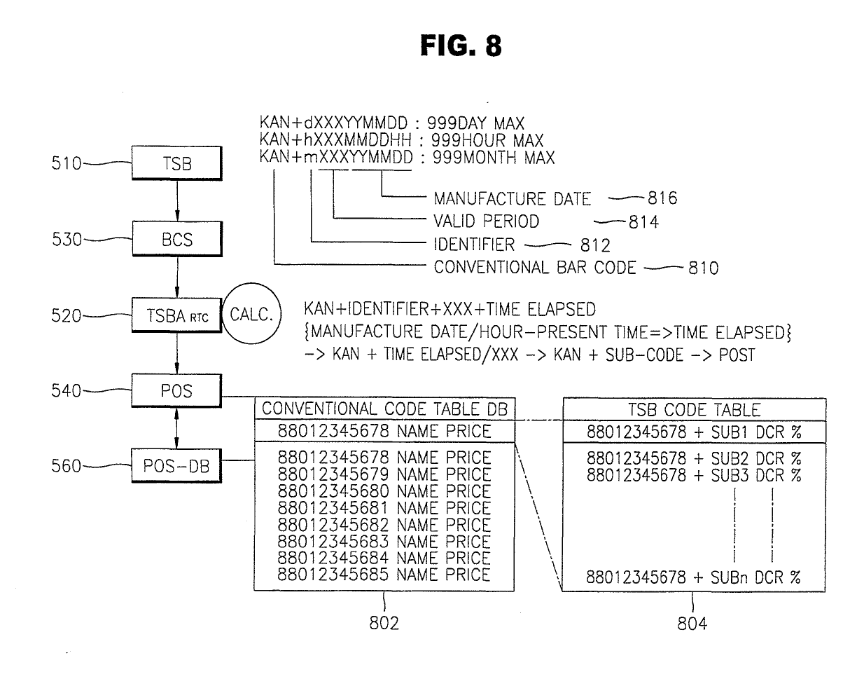

FIG. 8 is a block diagram of the dynamic price sales system shown in FIG. 5 for illustrating an example in which the TSBA is situated between the convention bar code scanner 530 and the POS terminal 540. The operator 524 (of FIG. 5) for calculating a valid period of the TSBA 520 calculates the expiration time and date elapsed, subtracts time elapsed from the valid period, divides the time equally, attaches an extended bar code to an article code, and applies a discount rate between POS terminals for supporting automatic calculation. Thus, an adaptor 520 is inserted between the POS terminal 540 and the bar code scanner 530, which recognizes a conventional bar code, and thus the TSB 510 and the conventional bar code are used compatibly. As an example of the TSB 510 shown in FIG. 8, an identifier 812, a valid period 814, and manufacture date/hour 816 are added to KAN, as a conventional bar code 810. Further, a TSB code table 804 is included in a POS database 560 with a conventional code table 802.

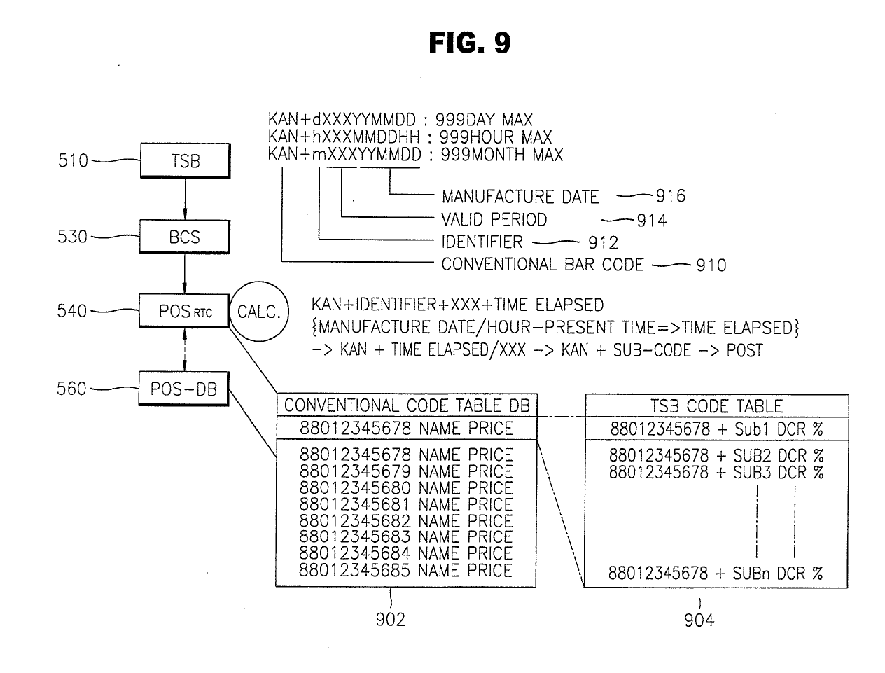

FIG. 9 illustrates an example in which a TSB algorithm is implemented by software in the conventional POS terminal 540, and database 560. In FIG. 9, a program, in which the TSBA shown in FIG. 8 is not used and to which a TSB algorithm is applied, is applied to the conventional POS terminal 540, thereby realizing a dynamic price sales system. As shown in FIG. 9, a software routine in which a time stamp sales algorithm is applied to the conventional POS terminal having a RTC is added, thereby performing all functions of a digital filter and an operator for calculating a valid period of the TSBA shown in FIG. 8.

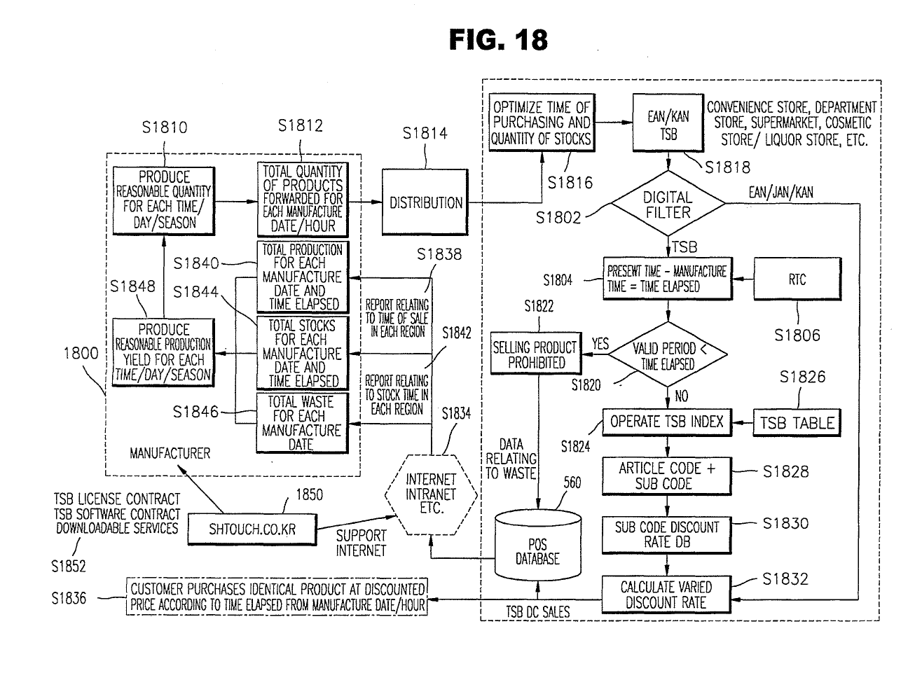

The TSB sales algorithm applied to the POS terminal 540 of FIG. 9 is shown in FIG. 18. Referring to FIG. 18, when conventional article codes such as EAN, KAN, and JAN, are recognized and entered into the bar code scanner 530 (of FIG. 9) functioning as (S1802) a digital filter, calculation of a discount rate is performed in (S1832). When a TSB 510 (of FIG. 9) including predetermined valid period and identifier is recognized and entered into the bar code scanner 530, a price varied according to the time elapsed from manufacture date/hour to time of sale, the valid period, and the identifier is calculated by referring the present time entered from the RTC (S1806) functioning as (S1804) an operator for calculating a valid period. In other words, the time elapsed from the valid period is calculated, a dynamic price is applied to an identical product, sales amount and the amount of stocks according to the time elapsed from the valid period can be determined using a database by calculating an expiration time for each item.

Thus, in the dynamic price sales system, in a case where the RTC and a program is included in the conventional POS terminal, the hardware adaptor (TSBA) is implemented by a software routine, which performs all the functions of a digital filter, and an operator for calculating a valid period is performed. Thus, the time elapsed from the valid period is calculated, a dynamic price is applied to an identical product, and an expiration time for each item can be calculated. An example of the TSB 510 is shown in FIG. 9 where an identifier 912, a valid period 914, and manufacture date/hour 916 are added to KAN as a conventional bar code 910. Further, a TSB code table 904 is included in a POS database 560 with a conventional code table 902.

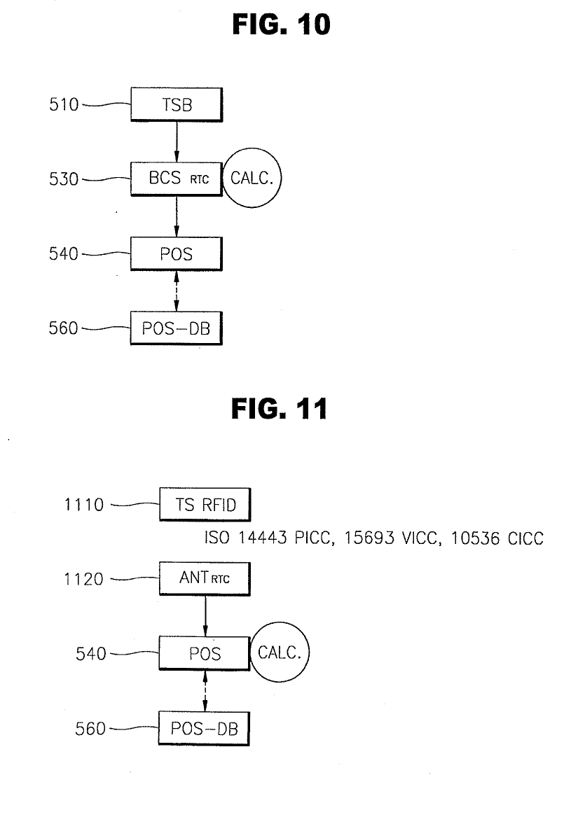

FIG. 10 illustrates an example in which a TSB function is applied to a bar code scanner having the RTC 510. In FIG. 10, the functions of a RTC, a digital filter, and an operator are incorporated into the bar code scanner, instead of being implemented by software at the POS terminal shown in FIG. 9. That is, a conventional bar code scanner reads an article code, such as EAN/KAN/JAN, through laser, a CCD array, CCD matrix, or a photo transistor, converts signals resulted from the read function into digital signals, and transmits data to the POS terminal or a related terminal by decoding the digital signals. The bar code scanner shown in FIG. 10 recognizes a bar code including a manufacture date/hour, a valid period, and an identifier by using the same method as the scanning method used in the conventional bar code scanner, and decodes signals by using the same method used in the conventional bar code scanner. However, after that, the bar code scanner shown in FIG. 10 performs a time stamp function for calculating time elapsed using the RTC in the bar code scanner having data provided by the TSB, generates a sub bar code relating to time elapsed or a discount rate including the original data of a conventional bar code, and transmits data to a POS terminal or another terminal.

FIG. 11 illustrates an example in which a time stamp is applied to a radio frequency (RF)-ID. Referring to FIG. 11, an antenna (ANT) (1120) including a RTC recognizes a RF-ID (1110) including a time stamp (TS) and transmits the RF-ID to the POS terminal 540. The POS terminal 540 is connected to the POS database 560 and compares the manufacture date/hour with the present time, thereby calculating time elapsed and determining a discount rate and a selling price. Thus, the present invention is not limited to a bar code including a manufacture date/hour and a valid period but may be applied to a RF-ID or a similar code.

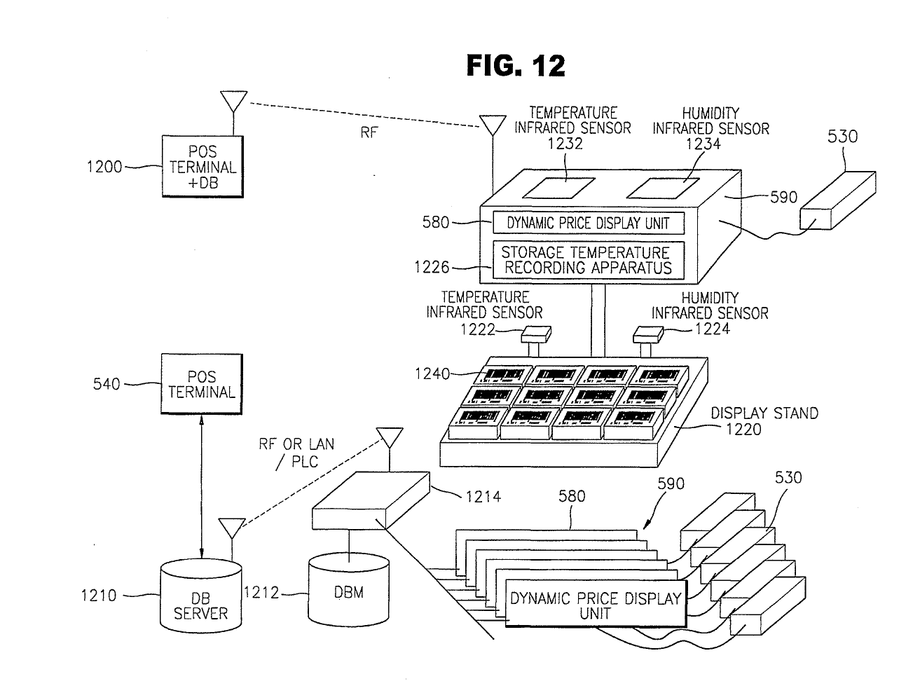

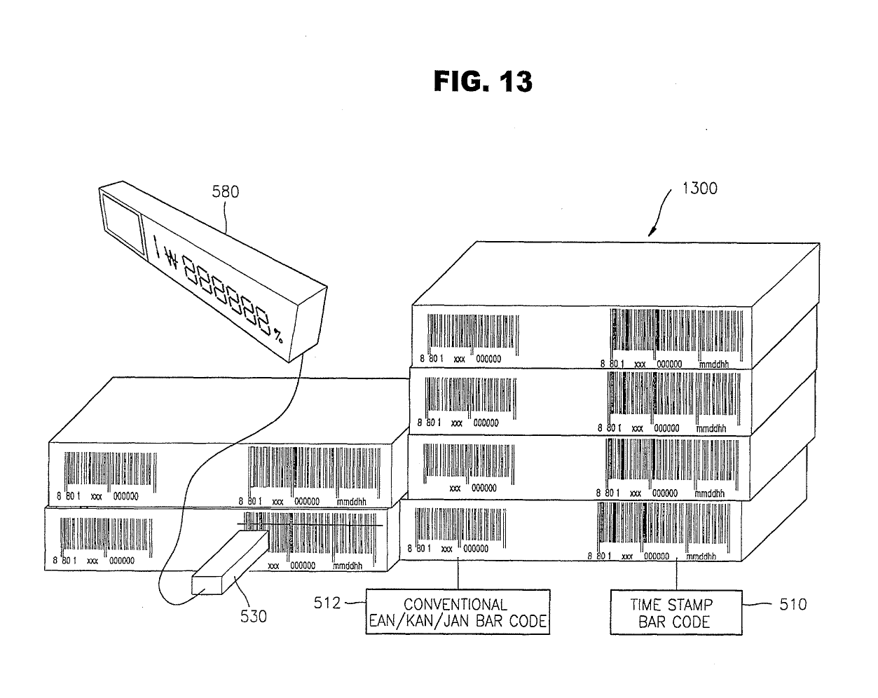

FIG. 12 illustrates a price inquiry apparatus 590 of a product employing a TSB, and FIG. 13 illustrates an example in which the TSB is recognized by the bar code scanner and the present price of the product is checked.

In the product employing a TSB, a dynamic price is automatically calculated and displayed at the POS terminal by using the dynamic sales system according to the time elapsed from the manufacture date/hour. However, if a customer wants to check the present price at a display stand on which the product employing a TSB is displayed, a price inquiry apparatus 590 in the display stand is necessary. Thus, the dynamic price sales system includes a price inquiry apparatus 590. The price inquiry apparatus 590 inquires about the present price of a product from a separate hard disk in which the dynamic price database (1200) of a server is referred, and displays the price on a dynamic price display unit 580, allowing a customer to check the present price. Referring to FIG. 12, the price inquiry apparatus 590 is located near a display stand 1220 and includes a dynamic price display unit 580, a storage temperature recording apparatus 1226, a first temperature infrared sensor 1232, and a first humidity infrared sensor 1234. The storage temperature recording apparatus 1226 may be installed outside the price inquiry apparatus 590 and records the temperature at a place 1220 where a product is kept. As shown in FIG. 12, a second temperature infrared sensor 1222 and a second humidity infrared sensor 1224 may be installed outside the price inquiry apparatus 590. The price inquiry apparatus 590 senses data relating to the temperature and humidity at a place 1220 where a product 1240 is stored or displayed by using the first and second temperature infrared sensors 1232 and 1222 and the first and second humidity infrared sensors 1234 and 1224, and records the data according to time elapsed from the manufacture date/hour when inquiring about the price of the product 1240 to which a time stamp bar code is attached. Data relating to temperature and humidity may be displayed on the dynamic price display unit 580. Further, the recorded data relating to temperature and humidity are transmitted to the TSBA 520 (of FIG. 8), the POS terminal 540 (FIG. 9), or the bar code scanner 530 (of FIG. 10), all of which are used to calculate a varied price, through a radio frequency (RF) or a wire, and thus data relating to the temperature and humidity at the place 1220 where a product is stored or displayed are further referred to when calculating a varied price.

The dynamic price in the POS terminal 540 is duplicated, or a receiving portion 1214 receives data relating to a product through a database manager (DBM) 1212 through a RF and/or a wire (LAN/PLC) from the POS server 1210. The present price of the product is indicated on the dynamic price display unit 580 according to data such as a discount rate for the product received by the receiving portion 1214 and according to the contents of a bar code of the product recognized by the bar code scanner 530 such that a customer can select a desired product.

In FIG. 13, a product 1300 employing a TSB is used together with a conventional bar code 512, such as EAN/KAN/JAN. The product employing a TSB applies a dynamic price at a TSBA or an enhanced POS (E-POS) terminal having a software algorithm in which a TSBA or TSB can be recognized, and collects and provides various data for checking the life cycle of products required by manufacturers, thereby optimizing and determining the production quantity according to the forwarding time of a product to reduce the manufacturing cost and to increase the added value of distribution. The conventional bar code 512 and the TSB 510 are printed on or attached to the product such that the present price of the product can be calculated at a conventional POS terminal in which hardware or software for recognizing the TSB is not yet introduced. As shown in FIG. 13, the conventional bar code 512 and the TSB 510 are printed on or attached to the product 1300 employing a TSB and are scanned by the bar code scanner 530, and thus the present price is indicated on the dynamic price display unit 580.

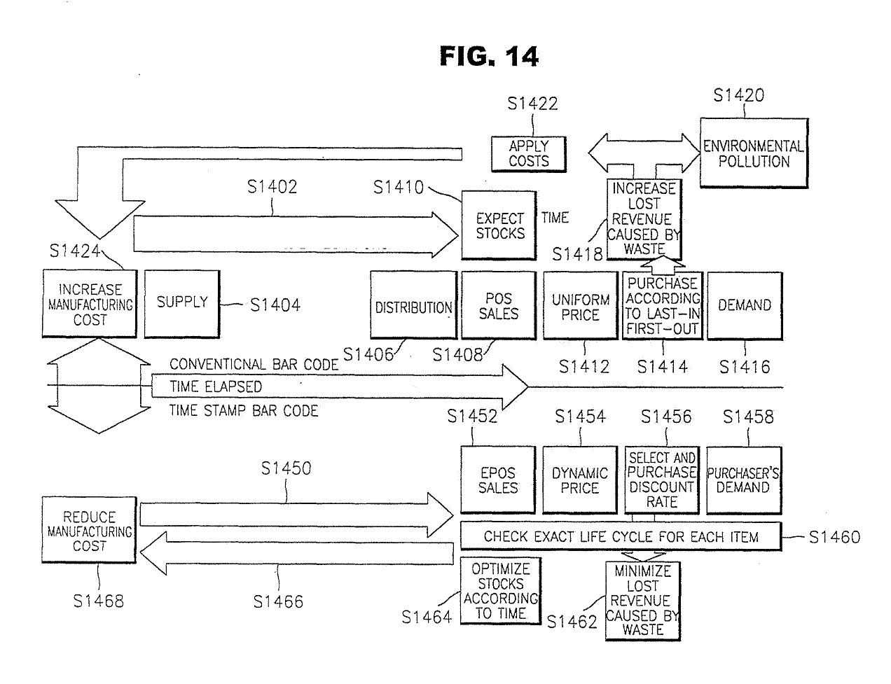

FIG. 14 illustrates a dynamic price sales method having time elapsed, and a stock-optimization enhanced structure.

When using a conventional bar code, the quantity of a product is determined (S1402) according to statistics and expectations, and the product is supplied (S1404) and distributed (S1406). As the product sold (S1408) at the POS terminal is sold at a uniform price (S1412), a purchaser's demand (S1416) is made by purchasing (S1414) according to last-in first-out where the latest manufacture date is preferred. Since products having an older manufacture date remain as stocks (S1410), a lost revenue caused by waste increases (S1418), and such a loss is applied to costs (S1422), and thus, a purchaser purchases an identical product at a higher price as a manufacturing cost increases (S1424). Further, environmental pollution (S1420) occurs due to waste of stocks.

However, in a case of using a time stamp bar code, the quantity of a product can be optimized (S1450) on the basis of statistical data recorded at a time when the product having a TSB is manufactured and sold. The product sold (S1452) at the enhanced POS (E-POS) terminal is sold at a dynamic price (S1454), and a purchaser's demand (S1458) is made by referring a discounted price and by purchasing (S1456) the product, thereby realizing a first-in first-out method in which a product having an older manufacture date is sold at a discounted price. Thus, stocks are reduced, and a lost revenue caused by waste is minimized (S1462) so that a supplier can reduce costs. The exact life cycle for each item can be checked (S1460) according to manufacture date/hour and a valid period included in the TSB of the product, and stock quantity according to time is optimized (S1464), and the quantity of the product according to time is requested (S1466), and thus the manufacturing cost is reduced (S1468).

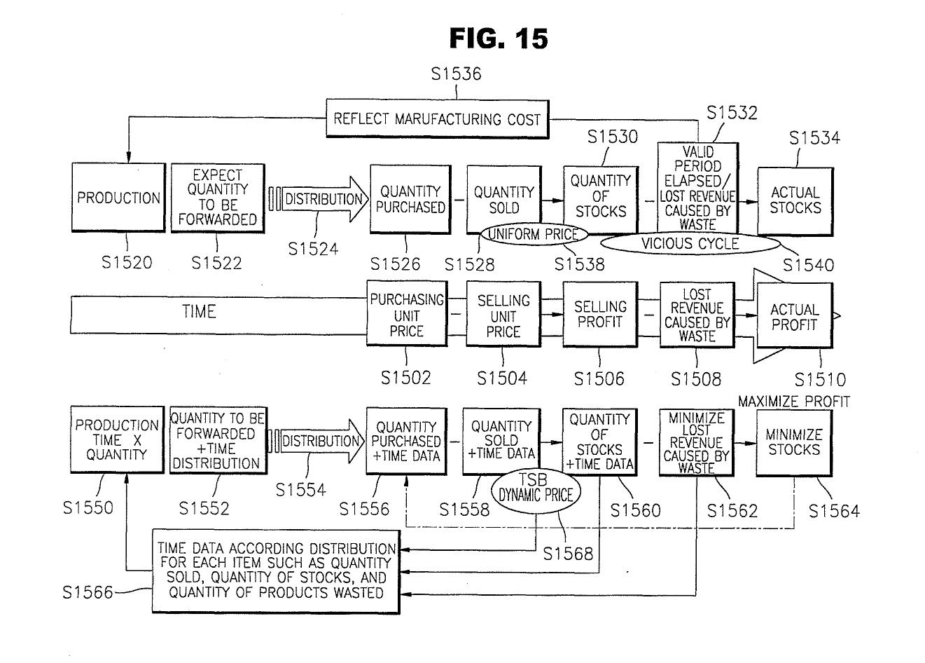

FIG. 15 illustrates a method for reducing a manufacturing cost resulting from inventory control according to time elapsed from manufacture date of each item and calculation of reasonable production according to time.

In general, the difference between a purchasing unit price (S1502) and a selling unit price (S1504) is a selling profit (S1506). A lost revenue caused by waste (S1508) subtracted from the selling profit (S1506) yields an actual profit (S1510). Maximization of the actual profit can be of benefit to a distributor, a manufacturer, and a customer.

In a case of using a conventional bar code system, a product is produced (S1520) and distributed (S1524) according to expectations (S1522) of the quantity to be forwarded. The quantity sold (S1528) subtracted from the quantity purchased (S1526) by a distributor gives the quantity of stocks (1530). The quantity wasted (S1532) of the product having an expired valid period is subtracted from the quantity of stocks (S1530) to give actual stocks (S1534). Since the product having a more recent manufacture date tends to be sold at a uniform price (S1538), a vicious cycle (S1540) in which the quantity of products wasted increases, continues, is reflected (S1536) to the manufacturing costs, the products are produced (S1520), and thus disadvantages are brought to all of a manufacture, distributor and customer.

In a case of using a time stamp bar code system, time data is added to the time stamp bar code system. The quantity to be forwarded and time (S1552) is determined by referring to a database storing when and how much of the product is sold, and the product is produced (S1550) and is distributed (S1554). The quantity sold (S1558) is subtracted from the quantity purchased (S1556) purchased by a distributor to give the quantity of stocks (S1560). The quantity of products wasted (S1562), i.e., products having an expired valid period, of the quantity of stocks (S1560) is minimized as the product is sold at a TSB dynamic price (S1568), and actual stocks (S1564) are minimized since the quantity (S1556) purchased by a distributor referring a database is proper. Further, the time data (S1566) according to distribution for each stage, such as the quantity sold (S1558), the quantity of stocks (S1560), and the quantity wasted (S1562), are stored in the database and mirrored to production (S1550).

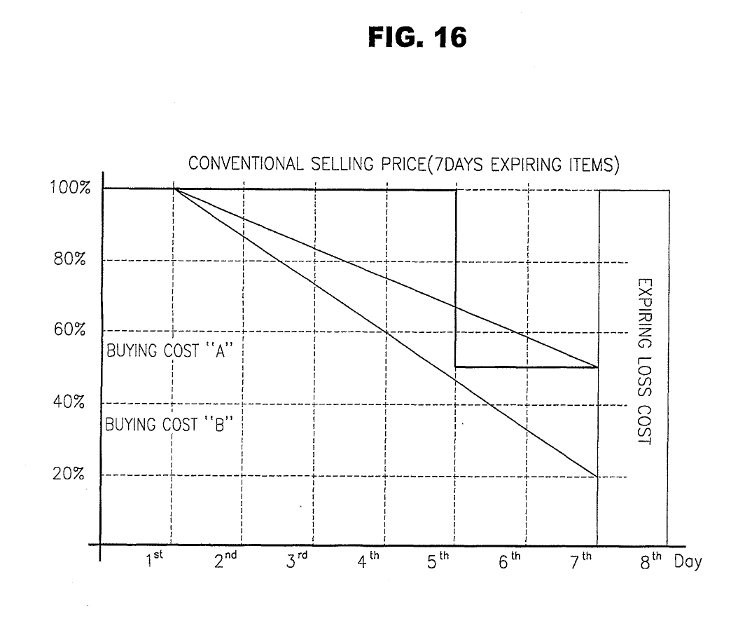

FIG. 16 illustrates a method for calculating a dynamic price of an item, which is perishable according to the time elapsed since distribution.

As shown in FIG. 16, a conventional selling price is maintained at an original selling price until an expiration date approaches, and when the expiration date approaches, the conventional selling price is reduced, for example, to 50% of the original selling price starting from the 6th day before the expiration date. On the other hand, the selling price according to the present invention is discounted as time elapses.

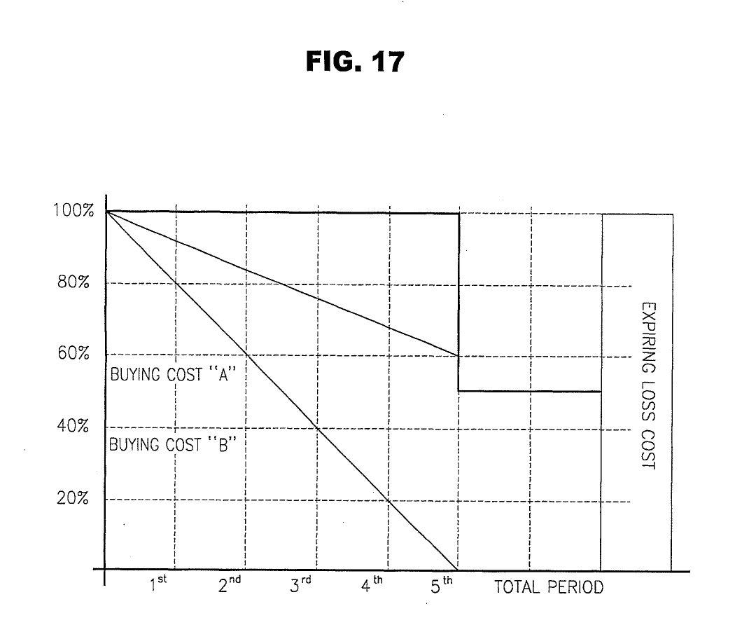

FIG. 17 illustrates a method for indicating a discount rate according to time by a TSB index. As an example employing a dynamic price, the dynamic price can be calculate by a dynamic price index (DPI) which divides a discount critical rate (DCR) by a valid period T. Of course, a distributor can refer to the DPI and employ the dynamic price through the experience of his own profit and a selling profit.

FIG. 18 illustrates a TSB sales algorithm. Referring to FIG. 18, a reasonable quantity of products for each time/day/season is produced (S1810), and thus the total quantity of products forwarded (S1812) for each manufacture date/hour is determined and the products are distributed (S1814). Time of purchasing and the quantity of stocks are optimized for a convenience store, a department store, a supermarket, a cosmetic store, and a liquor store. Then, products are purchased (S1816). A product may have a conventional article code, such as EAN/JAN/KAN, or a TSB article code (S1818). It is determined whether the conventional article code such as EAN/KAN/JAN is input into a digital filter, or whether a TSB including a predetermined valid period and a predetermined identifier is input into the digital filter (S1802). When the conventional article code is input into the digital filter, a discount rate is applied such that a varied discount price is calculated (S1832). When the TSB is input into the digital filter, elapsed time is calculated (S1804) by subtracting the manufacture time from the present time input by the RTC (S1806). Next, it is determined whether the elapsed time calculated in (S1804) is longer than the valid period included in the TSB article code (S1802). When the elapsed time is longer than the valid period, the product exceeds the valid period, and thus selling of the product is prohibited (S1822), and data relating to waste are stored in the POS database 560. When the elapsed time is shorter than or the same as the valid period in (S1820), a TSB table (S1826) is referred to, and thus a TSB index is operated (S1824), and a sub bar code relating to the article code, the time elapsed, and the valid period is generated (S1828). The database including the sub bar code and a discount rate, is referred to (S1830), and thus the discount rate is applied such that the varied discount price is calculated (S1832). Thus, a customer purchases an identical product at a discounted price according to the time elapsed from manufacture date/hour (S1836).

Meanwhile, SHT Co., Ltd., an applicant of the present invention, provides a TSB license contract, a TSB software contract, and downloadable services to a manufacturer 1800 through contents supported by a web site http://www.shtouch.co.kr 1850 (S1852). Further, the contents stored in the POS database 560 by internet and intranet (S1834) supported by the web site 1850 are provided to the manufacturer 1800. That is, a report (S1838) relating to time of sale in each region, a report relating to a stock time in each region (S1842), and a report relating to a waste time in each region are provided to the manufacturer 1800, and thus total production (S1840) for each manufacture date and time elapsed, total stocks (S1844) for each manufacture date and time elapsed, and total waste (S1846) for each manufacture date are calculated, and thus a reasonable production yield (S1848) for each time/day/season is determined.

As described above, according to the present invention, sellers can sell foods within a valid period at a price varied according to the time elapsed from a manufacture date such that customers can purchase products selectively. As a result, a first-in first-out system out of products having limited valid periods is smoothly achieved, thereby lowering the quantity of products whose expiration date have elapsed, reducing waste processing caused when the valid periods of products, such as foods, exceeded, and returning profits to suppliers, manufacturers, distributors, sellers, and customers.

Further, the valid period can be included in the time stamp bar code (TSB), of which an application for a patent has been filed by the applicant, and thus a simple software or hardware adaptor can be added to the conventional POS system, time elapsed can be simply and effectively calculated, and a price varied according to the time elapsed from the manufacture date can be employed.

Thus, when a discount rate varied according to the characteristics of products and the time elapsed from the manufacture date is employed, and a product employing the discount rate is sold, customers can selectively purchase an identical product at a price varied according to the time elapsed from the manufacture date.

Compared with a conventional uniform price sales method, a distributor can selectively sell foods having an predetermined life cycle at prices varied according to the time elapsed from the manufacture date, thereby preventing last-in first-out, reducing the quantity of products wasted, reducing a lost revenue caused by waste, and maximizing profits.

A manufacturer can determine a reasonable production yield for each manufacture date of products on the basis of data relating to time of sale elapsed from a production time of each item, data relating to stocks, and data relating to waste, and can supply an optimal quantity of products to a market, thereby reducing over-production and overstocking, and finally, reducing a manufacturing cost. In other words, the life cycle of a product, which cannot be checked by a conventional distribution method, can be determined, for example, on the basis of data related to when the product was manufactured and forwarded what price the product was sold at, how many products remained, and how many products was wasted. Thus, a reasonable production yield for each time period can be determined, thereby minimizing a manufacturing cost. That is, a reasonable production yield can be determined according to consumption patterns for each day/month/season/time, and the manufactured product can be supplied to the market, thereby reducing over-production, overstocking, and the quantity of products wasted caused by an elapsed valid period.

Further, the time stamp bar code of the present invention can be employed in a general product, which may or may not have a limited life cycle, and thus it can be known when supplied products are sold, how many products remain according to time elapsed, and how the products are distributed according to time, thereby causing renovation and determining the most optimized time and quantity. Production and supply are not made by simple expectations but by the optimization of sales caused by optimized stocks in each region for each demand time. As a result, costs can be reduced, and waste can be minimized, thereby causing a renovation in distribution.

In particular, the possibility that foods are sold after their expiration dates have elapsed because of a mistake made by a store clerk is prevented completely, thereby solving a problem of harm done to the human body, such as food poisoning occurring, because of a conventional sales method.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A variable price-based sales system, comprising:
a first bar code scanner for reading a bar code including a country of origin, a manufacturer code, a product code, a date of production and a valid period of a product, and an identifier (ID) indicative of a type of valid period;
a first time stamp bar code adaptor for receiving the bar code scanned by the first bar code scanner, extracting the country of origin, the manufacturer code, the product code, the date of production, the valid period and the ID from the received bar code, and generating a sub code indicative of a ratio of a period, having elapsed from the data of production, to a point of sales, to the valid period based on the elapsed period, the valid data, and the ID; and
a point of sale (POS) terminal for managing a product code table, and a time stamp code table containing discount rate information set by a product manufacturer, and calculating a discount price based on the elapsed period using the bar code and the sub code provided by the time stamp bar code adaptor.

2. The variable price-based sales system of claim 1, wherein the first time stamp bar code adaptor comprises:
a digital filter;
a real time clock (RTC) having the present date and time; and
an operator for calculating the valid period;
wherein the digital filter extracts the country of origin, the manufacturer code and the product code from the bar code and transmits them to the POS terminal, and extracts the date of production, the valid period and the ID from the bar code and transmits them to the operator for calculating a valid period; and
wherein the operator for calculating the valid period generates a sub code indicative of the ratio of the period, having elapsed from the data of production to the point of sales, to the valid period based on the date of production, the valid period and the ID provided by the digital filter, and provides the sub code to the POS terminal.

3. The variable price-based sales system of claim 2, wherein:
the ID distinguishes between no valid period, an hour-based valid period, and a date-based valid period; and
the operator for calculating a valid period determines a unit of the valid period while making reference to the ID.

4. The variable price-based sales system of claim 3, wherein the operator for calculating a valid period provides notification of a sales prohibition to the POS terminal when a point of sales comes after the valid period.

5. The variable price-based sales system of claim 4, wherein the POS terminal generates information indicative of discarding an inventory of the corresponding product when the notification of the sales prohibition is provided by the operator for calculating a valid period.

6. The variable price-based sales system of claim 1, further comprising a variable price inquiry device for inquiring into the price which varies depending on the elapsed period.

7. The variable price-based sales system of claim 6, wherein the variable price inquiry device comprises:
a second bar code scanner;
a second time stamp bar code adaptor; and
a display unit for displaying a discount rate for a sub code calculated by the second time stamp bar code adaptor.

8. The variable price-based sales system of claim 7, wherein the variable price inquiry device further comprises a recording device for recording temperature and humidity data, provided by temperature and humidity sensors installed at a place where the product is stored or displayed, over time.

9. The variable price-based sales system of claim 8, wherein the variable price inquiry device provides the temperature and humidity data, recorded by the recording device, to the POS terminal when the price is inquired.

10. The variable price-based sales system of claim 1, wherein the POS terminal is programmed to allow the variable price to be calculated based on a discount rate set by a product seller when there is no sub code generated by the operator for calculating a valid period.

11. The variable price-based sales system of claim 10, wherein the POS terminal makes reference to the temperature and humidity data, transmitted by the variable price inquiry device, when determining the variable price.

12. The variable price-based sales system of claim 11, further comprising a POS server for managing the product code table, and the time stamp code table, containing the discount rate information set by the product manufacturer, and for providing the product code table and the time stamp code table to the POS terminal in response to a request from the POS terminal.

13. The variable price-based sales system of claim 9, further comprising a POS server for managing the product code table, and the time stamp code table, containing the discount rate information set by the product manufacturer, and for providing the product code table and the time stamp code table to the POS terminal in response to a request from the POS terminal;
wherein the variable price inquiry device provides the temperature and humidity data, recorded by the recording device, to the POS terminal when the price is inquired; and
wherein the POS server adjusts the discount rate while making reference to the temperature and humidity data transmitted by the variable price inquiry device.

14. A variable price-based sales system, comprising:
a bar code scanner for reading a bar code including a country of origin, a manufacturer code, and a product code and/or a date of production, a valid period of a product, and an ID for the valid period; and
a POS terminal for extracting the date of production, the valid period, and the ID for the valid period from the bar code scanned by the bar code scanner, and for calculating a price which varies depending on a period having elapsed from the date of production to a point of sales, the valid period and the ID.

15. The variable price-based sales system of claim 14, wherein the POS terminal comprises:
a Real Time Clock (RTC) having a current date and time; and
memory for storing a software routine, the software routine comprising a digital filter module for managing a product code table and a time stamp code table, containing discount rate information for each sub code set by a product manufacturer, and for extracting the date of production, the valid period and the ID for the valid period from the bar code, and an operator module for generating a sub code indicative of a ratio of a period, having elapsed from the data of production to the point of sales, to the valid period based on the current date and time provided by the RTC and the date of production, the valid period and the ID provided by the digital filter, and for calculating a variable price for a product based on the product code and the sub code.

16. The variable price-based sales system of claim 15, wherein the software routine is programmed to allow the variable price to be calculated depending on a discount rate set by a product seller when the bar code includes no date of production and no valid period.

17. A variable price-based sales method, comprising:
indicating, by a POS terminal, a sales price of a product, where a bar code including a product code, a date of production and a valid period of the product is attached, calculated according to a dynamic discount rate based on an elapsed time from the date of production to a point of sales;
transmitting, by a POS terminal, a total sales and a total stock in respect to the elapsed time to a POS database;
maintaining, by the POS database, the total sales and the total stock in respect to the elapsed time for the reference of the manufacturer.

18. The variable price-based sales method of claim 17,
Wherein the POS terminal transmits not only the total sales and the total stock but also an amount of discarded product whose valid period is over, and the POS database maintains the total sales, the total stock and the amount of discarded product.

19. A variable price-based sales system, comprising:
a point of sale (POS) terminal for indicating a sales price of a product, where a bar code including a product code, a date of production and a valid period of the product is attached, calculated according to a dynamic discount rate based on an elapsed time from the date of production to a point of sales and transmitting a total sales and a total stock in respect to the elapsed time to a POS database; and
POS database for maintaining the total sales and the total stock in respect to the elapsed time for the reference of the manufacturer.

20. The variable price-based sales system of claim 19,
Wherein the POS terminal transmits not only the total sales and the total stock but also an amount of discarded product whose valid period is over, and the POS database maintains the total sales, the total stock and the amount of discarded product.
